(19) United States
(12) Patent Application Publication
(10) Pub. No.: US 2019/0112520 A1
(43) Pub. Date: Apr. 18, 2019

(54) METHOD FOR COATING SUPPORT AGENTS WITH MODIFIED REACTIVE RESIN COMPOSITIONS, COATED SUPPORT MEANS AND USE OF THE COATED SUPPORT MEANS IN FRACKING-CONVEYING METHODS

(71) Applicant: Wacker Chemie AG, Munich (DE)

(72) Inventors: Sebastian KNOER, Emmerting (DE); Daniel CALIMENTE, Saline, MI (US); Arndt SCHLOSSER, Stammham (DE)

(73) Assignee: Wacker Chemie AG, Munich (DE)

(21) Appl. No.: 16/089,917

(22) PCT Filed: Apr. 1, 2016
(86) PCT No.: PCT/EP2016/057235

§ 371 Date: Sep. 28, 2018

(51) Int. Cl. C09K 8/80

(52) U.S. Cl. CPC C09K 8/805; C09D 161/06

(57) ABSTRACT

Proppants coated with a curable resin containing 2.5-12% of a hydrophobic fumed silica having a BET surface area of 20 to 600 m²/g exhibit high resistance to cracking and flaking, and are useful in fracking operations in subterranean formations for recovery of oil and/or gas.

### CROSS REFERENCE TO RELATED APPLICATIONS

This application is the U.S. National Phase of PCT Appln. No. PCT/EP2016/057235 filed Apr. 1, 2016, the disclosure of which is incorporated in its entirety by reference herein.

### BACKGROUND OF THE INVENTION

### 1. Field of the Invention

The present invention relates to a method for proppant coating using modified reactive resin compositions, and to the use thereof in hydraulic fracturing (“fracking”).

### 2. Description of the Related Art

The fracking method is used in mineral oil and natural gas production and is a method of generating, widening and stabilizing cracks in the rock of a deposit deep underground, with the aim of increasing the permeability of the deposit rock. As a result, gases or liquids present therein can flow in an easier and more stable manner to the well and be recovered.

The cracks generated have to be kept open with proppants. The coated or uncoated proppants currently available are brittle and do not have the necessary compressive strength for production at great depths. The breaking of the proppant under the high pressure releases fine particles that block the cracks and reduce the oil or gas production rate.

The coated proppants available according to the prior art have improved stability compared to uncoated proppants. However, the effect of the coating, for example with organic resins, is limited by the fact that the available coatings themselves are very brittle and likewise have a tendency to break or to flake off.

WO2008088449 A2 discloses a means of reducing the brittleness of coatings of such particles, wherein thermally curing reactive resins, for example epoxy resins, are admixed with block copolymers and adhesion promoters in order thus to achieve an improvement in the impact resistance of the coating. As well as the use of two additives, an additional disadvantage is that the toughness improver is a costly block copolymer which is difficult to prepare.

US2012088699A proposes coating particles with at least two oleophilic and hydrophobic resins, for example epoxy resins and silicone resins. The particles thus coated improve the oil yield and reduce the amount of water produced. The use of silicone resins makes these particles costly.

U.S. Pat. No. 8,852,682B2 discloses particles for use as proppant materials which have a coating of multiple layers interleafed together. A filler is explicitly metered in during the individual process steps. A disadvantage is the complex process. Various resins are used for coating, for example phenolic resins containing fumed silicas, for example, as reinforcing fillers.

U.S. Pat. No. 5,422,183A discloses particles for use as proppant materials in fracking methods that likewise have a two-layer coating composed of resins. Phenolic resins, for example, are used for coating, wherein fumed silicas are likewise used as filler. This filler is introduced into the interphase of the individual layers after the first coating step. A disadvantage in both documents is the very complex multistage process, which is costly and additionally difficult to control.

US20140124200A discloses the use of hybrid materials produced by chemical bonding of organic resins and silicone resins for coating of proppant materials. Disadvantages here are the use of costly silicone resins, an additional complex process for chemical modification, and the difficulty of controlling product quality in the case of reaction of two branched polymers.

In addition, processes that lead to a reduction in the brittleness of coatings are common knowledge in the prior art. WO2010060861A1 describes, for example, a homogeneous reactive resin which shows an improvement in the mechanical properties of fracture toughness and impact resistance as a cured thermoset. In this case, for example, at least one organopolysiloxane is homogeneously distributed in an unhardened epoxy resin with the aid of a silicone organocopolymer which serves as dispersant.

### SUMMARY OF THE INVENTION

It was therefore an object of the present invention to provide an inexpensive method for coating proppants and the coated proppants themselves. These proppants, after coating and curing, are to have the necessary hardness and simultaneously exhibit elastic properties such as good impact resistance, in order that there is no breaking or flaking-off of the coating. These and other objects are surprisingly achieved by the method of the invention for producing coated proppants, where a reactive resin composition in flowable form,
together with or without at least one hardener (C) and
with or without at least one additive (D),

is applied to the proppant

and is then hardened,

characterized in that

the reactive resin composition comprises
(A) 80-97.5% by weight of at least one reactive resin, and
(B) 2.5-20% by weight of at least one silica having a BET surface area to DIN ISO 9277/DIN 66132 of between 20 and 600 m²/g.

### DETAILED DESCRIPTION OF THE PREFERRED EMBODIMENTS

Preferably, the critical stress intensity factor, i.e. the K1c value, of the reactive resin composition of the invention is at least 0.55 MN/m^{3/2}, more preferably at least 0.6 MN/m^{3/2}, and most preferably at least 0.70 MN/m^{3/2}. This value assesses the susceptibility of materials to cracking. The higher this value, the less the extent to which propagation of cracking occurs.

The K1c value was determined according to ASTM D 5045 on compact tensile specimens (CT test specimens) with W=35 mm and a strain rate of 1 ram/min. The CT test specimens with thickness 4.5 mm were produced by means of a CNC lathe and inscribed to 3 mm with a blade.

The reactive resin compositions used for the coating method of the invention comprise at least the components (A) and (B).

Component (A)

Preferably, the reactive resin composition of the invention comprises just one reactive resin (A).

The reactive resins (A) must form a firm, non-tacky coating at ambient temperatures. This is necessary in order that the coated particles remain free-flowing, such that they do not agglomerate under normal storage conditions. The coating can be substantially cured such that little or no crosslinking takes place under the influence of conditions within the borehole. The coating may also be only partly cured or be provided with other reactive groups, such that covalent crosslinking takes place under the conditions within the borehole.

Suitable reactive resins (A) in accordance with the invention are all polymeric or oligomeric organic compounds bearing a sufficient number of suitable reactive groups for a hardening reaction. All reactive resins known in the prior art that can be processed to thermosets are suitable, irrespective of the respective crosslinking mechanism that proceeds in the hardening of the respective reactive resin. In principle, they can be divided into three groups according to the nature of the crosslinking mechanism by addition, condensation or free-radical polymerization.

From the first group of the polyaddition-crosslinked reactive resins (A), preference is given to selecting one or more epoxy resins, urethane resins and/or air-drying alkyd resins as starting material. Epoxy resins and urethane resins are generally crosslinked by addition of stoichiometric amounts of a hardener containing hydroxyl, amino, carboxyl or carboxylic anhydride groups, the hardening reaction taking place by addition of the oxirane or isocyanate groups in the resin onto the corresponding groups in the hardener. In the case of epoxy resins, catalytic hardening is also possible by polyaddition of the oxirane groups themselves. Air-drying alkyd resins crosslink through autoxidation with atmospheric oxygen. Addition-hardening silicone resins are also known, preferably those with the proviso that no further free silanes are present.

Examples of the second group of reactive resins (A) that are crosslinked by polycondensation are preferably condensation products of aldehydes, e.g. formaldehyde, with aliphatic or aromatic compounds containing amine groups, for example urea or melamine, or with aromatic compounds such as phenol, resorcinol, cresol etc., and also furan resins, saturated polyester resins and condensation-hardening silicone resins. The hardening usually takes place here via increase in temperature with elimination of water, low molecular mass alcohols or other low molecular mass compounds.

From the third group of the chain-growth polymerization-crosslinked reactive resins, preferred starting resins for the reactive resins modified in accordance with the invention are one or more homo- or copolymers of acrylic acid and/or methacrylic acid or esters thereof, and also unsaturated polyester resins, vinyl ester resins and/or maleimide resins. These resins have polymerizable double bonds, the polymerization or copolymerization of which brings about three-dimensional crosslinking. The initiators used are compounds capable of forming free radicals, for example peroxides, peroxo compounds or compounds containing azo groups.

It is also possible to initiate the crosslinking reaction by means of high-energy radiation, such as UV or electron beams.

Not just the aforementioned reactive resins (A) but also all others suitable for production of thermosets can be modified in the manner proposed in accordance with the invention and, after crosslinking and hardening, result in thermosets having considerably improved fracture toughness and impact resistance, with retention of other essential properties characteristic of thermosets, such as strength, heat distortion resistance and chemical resistance, in an essentially unaffected manner.

The preferred reactive resins (A) are the phenol-formaldehyde resins. These reactive resins (A) include thermosetting phenolic resins of the resole type and phenol-novolak resins, which can be rendered thermally reactive by addition of catalyst and formaldehyde. The reactive resins (A) can either be fully cured during the coating of the proppant particles or only partly cured. Proppants having an only partly hardened coating do not cure until they have been introduced into deeper strata during fracking.

Particularly preferred reactive resins (A) are phenol-novolak resins. These are obtainable, for example, from Plastics Engineering Company, Sheboygan, USA, under the Resin 14772 name. If such a reactive resin is used, it is necessary to add a crosslinking agent (C) to the mixture in order to bring about the subsequent curing of the reactive resin. Hexamethylene-tetramine is the preferred material as (C) for this function, since it serves both as catalyst and as formaldehyde source.

(A) is used in amounts of 80-99.5% by weight, preferably in amounts of 88-99% by weight and most preferably of 94-98% by weight.

Component (B)

Silicas have for a long time been available commercially from a variety of manufacturers.

(B) is a silica having a high BET surface area, measured accordingly to DIN ISO 9277/DIN 66132, of between 20 and 600 m²/g, preferably between 20 and 400 m²/g, and most preferably between 100 and 400 m²/g.

(B) preferably comprises precipitated and fumed silicas, most preferably fumed silicas.

(B) is preferably an unmodified silica or a hydrophobically modified silica having a carbon content, measured according to DIN EN ISO 3262-20, of 0-15% by weight, more preferably with a carbon content of 0-2.1% by weight.

Those skilled in the art have long been aware of hydrophobized silicas. The hydrophobization preferably takes place by means of halogen-free silanes, as described in EP1433749A1, for example.

Examples of hydrophilic silicas (B) are HDK® N 20, HDK® D05 and HDK® T30 (available commercially from Wacker Chemie AG, Munich), AEROSIL® 200 (available commercially from Evonik Degussa GmbH, Frankfurt am Main) and Cab-O-Sil® LM 150 (available commercially from Cabot GmbH, Rheinfelden).

Examples of hydrophobic silicas available in the trade are HDK® H18 and HDK® H20, loaded with the moiety —[Si(CH₃)₂—O]ₙ, HDK® H2000 loaded with the moiety —O—Si(CH₃)₃ (available commercially from Wacker Chemie AG, Munich), and also AEROSIL® 972 and AEROSIL® 805 (available commercially from Evonik Degussa GmbH, Frankfurt am Main).

Preferably (B) is a hydrophobic silica having a residual silanol content of at least 30%, more preferably at least 40%, or a hydrophilic silica. With more particular preference (B) is a hydrophobic silica having a residual silanol content of at least 50%, or a hydrophilic silica.

The residual silanol content is to be understood as the relative silanol content based on a hydrophilic silica with approximately 2 SiOH/nm².

The reactive resin compositions used for the coating method of the invention may be produced as follows:

In one embodiment, production is effected by dispersing (B) in (A) which is flowable at 20° C. or in (A) which has been rendered flowable by prior heating to up to 250° C. or in (A) which has been dissolved in a suitable solvent so as to render it flowable. If a solvent has been used, it can be evaporated thereafter. Suitable solvents are known to those skilled in the art and are selected depending on the reactive resin (A). In the case of phenolic resin, suitable solvents are, for example, ethyl acetate and acetone. Which solvents are suitable for which reactive resins is described, for example, in the following textbook: Polymer Handbook, volume 2, 4th ed.; J. Brandrup, E. H. Immergut, E. A. Grulke; John Wiley & Sons, Inc., 1999 (ISBN 0-471-48172-6).

Suitable mixers are, for example, laboratory stirrers, planetary mixers, dissolvers, rotor-stator systems, or else extruders, rolls, 3-roll mills, etc.

One skilled in the art is aware of various ways of coating proppants with resins from the prior art. These methods can also be used for the coating of proppants with the present reactive resin compositions of the invention.

In a preferred embodiment, the reactive resin composition of the invention, in flowable form—i.e. already flowable at 20° C. or melted by heating to 250° C. and therefore flowable or dissolved in a suitable solvent and therefore flowable—is applied to the proppant, for example by spraying or mixing, together with or without at least one hardener (C) and with or without at least one additive (D), and then cured. Suitable solvents have already been described earlier on above.

In a further alternative production method for proppants coated in accordance with the invention, (A) is mixed with a suitable solvent, proppants and (B) and hence rendered flowable. It is optionally possible to add hardener (C) and possibly various additives (D) to the mixture. Subsequently, the solvent is evaporated off and the proppants thus coated are hardened. The sequence of addition of components (A), (B), (C) and (D) is variable.

In a particularly preferred possible embodiment, a suitable proppant, for example sand, is preheated to about 170-260° C. In a mixer, the reactive resin composition of the invention, a suitable hardener (C) and optionally various additives (D) are then added.

In another alternative, a suitable proppant, for example sand, is preheated to about 170-260° C. In a mixer, (A), (B), a suitable hardener (C) and optionally various additives (D) are then added.

The production of layers should be understood as follows: multiple layers are produced in multiple successive coating and hardening cycles. In other words, after the wetting of the surface of the proppant with the reactive resin composition of the invention, this layer is at first partly or fully hardened. Subsequently, a new layer of the reactive resin composition of the invention is applied and again is partly or fully hardened.

This contrasts with the application of the reactive resin composition of the invention in portions in multiple steps without any substantial intermediate hardening of the individual portions, and only at the end is there partial or complete hardening. Thus, this leads only to a single layer.

Proppants

Suitable proppants have long been known to the person skilled in the art from the prior art and can be used for the coating of the invention. Proppants are typically hard particles of high strength, for example sand or gravel composed of rocks such as limestone, marble, dolomite, granite etc., but also glass beads, ceramic particles, ceramic spheres and the like, this list being illustrative and nonlimiting. Preferably, the proppant particles exhibit substantially spherical, i.e. ball-shaped, form, since these leave sufficient interspace in order that the crude oil or gas can flow past. Therefore, coarse-grain sand, glass beads and hollow glass spheres (called microballoons) are preferred as proppants. Particular preference is given to using sand as proppant.

Preferably, the proppant particles have an average size of 5000 to 50 μm, more preferably an average size of 1500 to 100 In addition, they preferably have a side ratio of length to width of not more than 2:1.

Hardeners (C)

Suitable hardeners have long been known to the person skilled in the art from the prior art and are selected in accordance with the reactive resin used. A preferred hardener (C) for novolaks is urotropin. The hardener (C), and thus also urotropin are typically used in amounts between 8 and 20% by weight, based on the amount of reactive resin composition of the invention. Preferably, urotropin is applied as an aqueous solution to the melt of the reactive resin. Methods of this kind are likewise known to those skilled in the art and are described, for example, in U.S. Pat. No. 4,732,920.

Additive (D)

Suitable additives (D) have likewise long been known to the person skilled in the art from the prior art. Non-exclusive examples are antistats, separating agents, adhesion promoters, etc.

Suitable proppants, hardeners (C) and additives (D) are described, for example, in U.S. Pat. No. 4,732,920 and US2007/0036977 A1.

For optimal performance of the proppant coated in accordance with the invention, the type and specification of the proppant, type and specification of the reactive resin (A), silica (B), hardener (C) and any additives (D), the type of mixing and coating process, the sequence of addition of the components and the mixing times have to be matched to one another according to the requirement of the specific application. A change in the proppant, under some circumstances, requires adjustment of the coating process and/or the hardeners (C) and additives (D) used.

A further subject is thus also the proppants that have been coated in accordance with the invention and are obtainable by the methods described above.

In the proppants of the invention, the surface of the proppant may have been wholly or partly coated. Preferably, on examination by scanning electron microscope, at least 20% of the visible surface of the proppant is seen to have been coated with the reactive resin composition of the invention, more preferably at least 50%.

Preferably, on examination by scanning electron microscope, at least 5% of the proppant particles are seen to be fully enveloped on their visible side, more preferably at least 10%.

The major portion of the coating on the proppant of the invention is 0.1 to 100 μm thick, preferably 0.1 to 30 μm, more preferably 1 to 20

Preferably, the proppants of the invention have been coated with fewer than three layers of the reactive resin composition of the invention, more preferably with just one layer.

The reactive resin composition in the method of the invention is preferably used in amounts of 0.1-20% by weight, based on the weight of the proppant, more preferably of 0.5-10% by weight and most preferably of 1-5% by weight.

A further subject of the present invention is the use of the proppants coated in accordance with the invention in fracking production methods for mineral oil and natural gas.

### Advantages of the Invention

Entirely surprisingly, it is found that the reactive resin compositions of the invention show advantages in coating of proppants in that the level of reject material resulting from sticking of the proppant of the invention is noticeably reduced.

The hardened reactive resin composition of the invention, and hence the proppant coated with it, has improved toughness, elasticity and formability at the same hardness. As a result, it is more resistant to stresses such as impacts, deformation or pressure and has a lower tendency to break.

The reactive resin composition of the invention, as a hardened coating for proppants, has improved breaking resistance, toughness and elasticity. The coating has a reduced tendency to break and flake off and protects the proppant more effectively and for a longer period of time against high pressures and impacts. Thus, the stability of the overall proppant is improved.

Conventional proppants according to the prior art are very brittle and have a high tendency to break. Breaking of the proppant results in release of fines. Release of fines has an adverse effect on the rate at which the crude oil or gas flows through, in that the interstices between the proppant grains are blocked. This quickly makes the oil or gas source unviable. New wells or refracking become necessary.

By contrast, the coated proppants of the invention are more resistant to stresses such as impacts, deformation or pressure and thus have a lower tendency to break.

A further advantage of the coating of the invention lies in its deformability, such that it frequently does not itself break on breakage of the brittle proppant grains and thus encases or holds together the resultant fines like a plastic shell and hence the release thereof is reduced overall.

These advantageous properties of the proppants coated in accordance with the invention allow oil or gas flow to be maintained for longer. This gives rise to crucial economic advantages and advantages in environmental protection.

### EXAMPLES

The examples which follow elucidate the invention without having any limiting effect. In the examples described hereinafter, all figures given for parts and percentages, unless stated otherwise, are based on weight. Unless stated otherwise, the examples which follow are conducted at a pressure of the surrounding atmosphere, i.e. at about 1000 hPa, and at room temperature, i.e. at 25° C., or at a temperature which is established on combination of the reactants at room temperature without additional heating or cooling. All viscosity figures hereinafter relate to a temperature of 25° C.

Abbreviations Used

The meaning of the abbreviations used earlier on above is also applicable to the examples:

PTFE=polytetrafluoroethylene

rpm=revolutions per minute

### Example 1

In a MOLTENI LABMAX with stripper and dissolver disk, 450 g of novolak “Resin 14772” (Plastics Engineering Company, Sheboygan, USA) were heated to 130° C. and melted, during which nitrogen was passed through the resin.

When all of the resin was melted, stirring was carried out at a vessel impulsion of 10 rpm and a dissolver speed of approximately 500 rpm for around 10 minutes. Then 50 g of HDK® N20 (hydrophilic silica with BET surface area of 170-230 m²/g; obtainable from Wacker Chemie AG) were incorporated in portions (small scoops, around 50-100 mL in volume) and stirred in at 500 rpm for around 2 minutes in each case. When all of the HDK had been added, the speed of the dissolver was raised to 4500 rpm, after which stirring continued for 10 minutes. While still hot, the material was subsequently poured onto a PTFE film and comminuted mechanically. The temperature after the homogenization was 165° C. Cooling produced a caramel-colored, odorless solid.

### Example 2

Using the method of example 1, 50 g of HDK® T30 (hydrophilic silica with BET surface area of 270-330 m²/g; obtainable from Wacker Chemie AG, Munich, Germany) were incorporated and comminuted mechanically. The temperature after the homogenization was 171° C. Cooling produced a caramel-colored, odorless solid.

### Example 3

Using the method of example 1, 50 g of microsilica (hydrophilic silica with BET surface area of 25-60 m²/g) were incorporated and comminuted mechanically. The temperature after the homogenization was 171° C. Cooling produced a caramel-colored, odorless solid.

### Example 4

Using the method of example 1, 50 g of HDK® H20 (BET surface area of the hydrophobic silica before hydrophobization was 170-230 m²/g; carbon content 1-1.8%; dimethylsiloxy surface modification; obtainable from Wacker Chemie AG) were incorporated and comminuted mechanically. The temperature after the homogenization was 165° C. Cooling produced a caramel-colored, odorless solid.

### Example 5

Using the method of example 1, 50 g of HDK® H18 (BET surface area of the hydrophobic silica before hydrophobization was 170-230 m²/g; carbon content 4-5.2%; poly-dimethylsiloxy surface modification; obtainable from Wacker Chemie AG) were incorporated and comminuted mechanically. The temperature after the homogenization was 172° C. Cooling produced a light yellow, odorless solid.

### Example 6

Using the method of example 1, 50 g of HDK® H2000 (BET surface area of the hydrophobic silica before hydrophobization was 170-230 m²/g; carbon content 2.3-3.2%; trimethylsiloxy surface modification; obtainable from Wacker Chemie AG) were incorporated and comminuted mechanically. The temperature after the homogenization was 148° C. Cooling produced a light yellow, odorless solid.

### Example 7

Using the method of example 1, 475 g of novolak “Resin 14772” (Plastics Engineering Company, Sheboygan, USA) were melted and 25 g of HDK® N20 (hydrophilic silica with BET surface area of 170-230 m²/g; obtainable from Wacker Chemie AG) were incorporated and comminuted mechanically. The temperature after the homogenization was 145° C. Cooling produced a light yellow, odorless solid.

### Comparative Example 1 (C1)

Using the method of example 1, 50 g of SILBOND® 600 TST (finely ground quartz with a BET surface area of 3 m²/g; dimethylsiloxy surface modification; obtainable from Quarzwerke GmbH, 50226 Frechen) were incorporated and comminuted mechanically. The temperature after the homogenization was 148° C. Cooling produced a dark brown, odorless solid.

### Comparative Example 2 (C2)

As comparative example C2, unmodified novolak “Resin 14772” (Plastics Engineering Company, Sheboygan, USA) is used.

Optimum pressure stability on the part of the coated filler requires precise harmonization of the type of proppant used, the type and amount of the resin used, and of the additive/additives used, the amount of hardener and the coating method. Resin properties are altered very markedly by incorporation of a filler by mixing into the phenolic resin. Depending on the type, the hydrophilicity and the BET surface area of the filler, it would be necessary to optimize the whole system anew for each silica, for a meaningful investigation of the pressure stability of coated proppants.

To be able to consider the advantages of different silicas in isolation, Q-PANEL test sheets were coated with a defined coating of the inventively modified phenolic resins from examples 1-7 and of the noninventively modified phenolic resin from comparative example C1 and of the noninventive, unmodified phenolic resin from comparative example C2.

The durability was tested using a ball impact tester. The result obtained indicates the elasticity, impact toughness and breaking strength of the coating.

### Example 8

Preparation of Reactive Resin Solutions for Production of Test Specimens and Coating of Q-PANEL Test Sheets:

10 parts in each case of the modified phenolic resins of the invention from examples 1-7, or 10 parts of the noninventive, modified phenolic resin from comparative example C1, or 10 parts of the pure, noninventive, unmodified phenolic resin, Resin 14772 (Plastics Engineering Company, Sheboygan, USA), were dissolved in each case together with in each case 1 part of urotropin and 10.0 parts of ethyl acetate (from Bernd Kraft, >=99%) by agitation overnight.

### Example 9

Production of Q-PANEL test sheets coated with phenolic resin: for the tests for determination of brittleness, Q-PANEL test sheets were cleaned 3× with acetone on the brushed side and then vented in a fume cupboard for an hour. Then 3 mL of the corresponding phenolic resin solution from example 8 was applied to each sheet and spread using a 100 μm doctor blade, after which the solution was evaporated off in a fume cupboard overnight.

For hardening, the samples were placed in a cold drying cabinet, heated to 160° C. over the course of 3 hours, under nitrogen blanketing, held at that temperature for 2 hours, and cooled to 23° C. overnight.

The evaporation of the solvent produces a hardened resin layer approximately 50 μm thick on the metal sheet.

### Example 10

Testing of Durability:

For verification of the improved properties, i.e. toughness and durability with respect to impact and pressure, according to examples 8 and 9, a hardened layer of the inventive resins from examples 1-3, 5 and 7 with a thickness of around 50 μm in each case, or, as comparative examples, a hardened layer, around 50 μm thick, of the unmodified resin, Resin 14772 (Plastics Engineering Company, Sheboygan, USA), and of the noninventive resin from comparative example C1, was produced on a Q-PANEL test sheet. The coated metal sheets were tested on an Erichsen ball impact tester, model 304-ASTM, and the results were evaluated visually by a trained tester: for this purpose, a ball is dropped from a defined, variable drop height onto the reverse side of the metal sheet (twin experiments in each case at different sites). The impact energy is found from the drop height multiplied by drop weight, reported in inches (in)×pounds (lbs). The impact energy is altered as follows: 5, 10, 15, 20, 25, 30, 35, 40 (in×lbs). The bulged impact sites are investigated visually for fissures and cracks and evaluated relative to the reference.

Table 1 shows the evaluation of the resin coating on Q-PANEL test sheets and the durability thereof by means of a ball impact tester.

TABLE 1

| Resin from | Siloxane | | |
|---|---|---|---|
| example | additive | Description | Evaluation |
| 1 | HDK ® N20 | no cracking or flaking | 5 |
| | (10%, w/w) | up to 40 in × lbs | |
| 7 | HDK ® N20 | Cracking at and above | 4 |
| | (5%, w/w) | 25 in × lbs, no flaking | |
| | | up to 40 in × lbs | |
| 2 | HDK ® T30 | No cracking or flaking | 5 |
| | (10%, w/w) | up to 40 in × lbs | |
| 3 | microsilica | Cracking at 10 in × lbs | 2 |
| | (10%, w/w) | and flaking at and above | |
| | | 25 in × lbs | |
| 5 | HDK ® H18 | Cracking at 10 in × lbs | 1 |
| | (10%, w/w) | and flaking at and above | |
| | | 10 in × lbs | |
| C1 | SILBOND ® | Cracking and flaking at | 0 |
| | 600 TST | and above 5 in × lbs | |
| | (10% w/w) | | |
| C2 | no additive | Cracking and flaking at | 0 |
| | | and above 5 in × lbs | |

The results of the ball impact tester were evaluated on a scale from 0 to 5, where 0 denotes the poorest result and 5 the best result.

It is found that the hardened coatings of the invention exhibit substantially improved elasticity, impact toughness and breaking strength in comparison to the unmodified comparative example C2 and to the noninventively modified comparative example C1.

### Example 11

Testing of Toughness:

According to example 8, solutions of the inventively modified phenolic resin from example 1 and of the unmodified comparative example C2 were prepared and were poured to a height of 12 mm into an aluminum mold and heated from 40° C. to 120° C. over 8 days. This is followed by heating for 2 hours each at 120° C., 140° C. and 160° C., with uniform cooling overnight. Test plates are produced that are hard and brown with a thickness of approximately 6 mm.

| Resin from | K1c |
|---|---|
| example | [MN/m^{3/2}] |
| 1 | 0.85 |
| C2 | 0.50 |

In comparison to the unmodified phenolic resin, the inventively modified resin exhibits an increased K1c value (determination analogous to the description above), which represents a measure of improved toughness, since the inventively modified resin displays minimal propagation of cracking.

1.-7. (canceled)

8. A method for producing coated proppants, comprising:
applying a reactive resin composition in flowable form, the composition optionally containing a hardener (C), and optionally containing additive(s) (D) to the proppant; and
then hardening at least part of the reactive resin thus applied,
wherein the reactive resin composition comprises
(A) 88-97.5% by weight of at least one reactive resin; and
(B) 2.5-12% by weight of at least one hydrophobically modified fumed silica having a BET surface area measured in accordance with DIN ISO 9277/DIN 66132, of between 20 and 600 m²/g, and having a carbon content measured in accordance with DIN EN ISO 3262-20, of 0-15% by weight.

9. The method of claim 8, wherein (B) comprises a hydrophobically modified silica having a carbon content measured in accordance with DIN EN ISO 3262-20 of 0-2.1% by weight.

10. The method of claim 8, wherein (B) comprises a has a BET surface area of 20-400 m²/g.

11. The method of claim 9, wherein (B) comprises a has a BET surface area of 20-400 m²/g.

12. The method of claim 8, wherein (B) has a BET surface area of 100 to 400 m²/g.

13. The method of claim 9, wherein (B) has a BET surface area of 100 to 400 m²/g.

14. A coated proppant obtained by the method of claim 8.

15. In a fracking production method for recovering oil or gas from a subterranean geological formation where a coated proppant is employed, the improvement comprising employing as a proppant, a coated proppant of claim 14.
